(19) United States
(12) Patent Application Publication
(10) Pub. No.: US 2026/0285536 A1
(43) Pub. Date: Sep. 24, 2026

(54) PAPER PROTECTIVE CASE FOR CLIP-ON PACKAGING AND DEVICE FOR MANUFACTURING THE SAME

(71) Applicant: Kingston Digital, Inc., Fountain Valley, CA (US)

(72) Inventors: Yen-Ning CHENG, Hsinchu (TW); Cheng-Hsien WU, Hsinchu (TW); Dian Marianatha CAI, Fountain Valley, CA (US); Jui-Tien CHANG, Hsinchu (TW)

(21) Appl. No.: 19/098,833

(22) Filed: Apr. 2, 2025

(30) Foreign Application Priority Data
Mar. 20, 2025 (TW) 114202751

(51) Int. Cl. B65D 5/20; B31B 50/20; B31B 50/26

(52) U.S. Cl. CPC B65D 5/2066; B31B 50/20; B31B 50/262

(57) ABSTRACT

A paper protective case, for clip-on packaging, including a paper card body is provided. The paper card body includes a middle block, two long side blocks, and two short side blocks, and the two long side blocks and two short side blocks are connected to the middle block respectively. The two long side blocks each include a first box wall portion and a first clamping portion connected to the first box wall portion. The two short sided blocks each include a second box wall portion and a second clamping portion connected to the second box wall portion. Each of the first clamping portions has a first clasping angle, and each of the second clamping portions has a second clasping angle, and two angles match each other. In this way, the entire packaging can be recycled and the product will not easily be stolen or replaced during delivery.

### PRIORITY

This application claims priority to Taiwan Patent Application No. 114202751 filed on Mar. 20, 2025, the entire content of which is hereby incorporated by reference.

### FIELD

The present invention relates to a paper protective case, and in particular, relates to a paper protective case used for clip-on packaging.

### BACKGROUND

How to make a product as environmentally friendly as possible from production to sales is a topic that all enterprises in the world attach great importance to at present.

Plastic blister packaging has advantages of light weight, transparency and easy shaping and has always been one of the packaging materials for small products favored by many manufacturers. It is usually used for bonding with a single piece of paper card 1 (referring to FIG. 1) to form the final outer packaging. This type of packaging technology is relatively mature, and if it is to be changed, then it will require a lot of research and development expenses, material expenses or the like. Therefore, for many manufacturers, plastic blister packaging and the process using the same cannot be easily replaced.

However, it is difficult for consumers to separate the final products of plastic and paper, and thus those products cannot be easily recycled separately, but treated as general waste, which will inevitably cause significant unavoidable contamination.

In order to achieve the goal of being environmentally friendly, some enterprises want to use paper materials or other recyclable materials to replace plastic blister packaging. For example, as shown in FIG. 1, the plastic blister packaging is substituted with paper blister packaging 2. However, the inventors have found that the package in this mode may be opened during delivery so that genuine products can be replaced by counterfeit ones, and then the package may be resealed without detection by consumers. Moreover, it is even easy to open the package and steal the products simply destroy a single side.

In order to improve the above defects, as shown in FIG. 2, the inventors have tried to use a clip-on and foldable paper card 3 to solve the problem that the paper blister package 2 (paper protective case) may be opened without detection. In the process, it was found that with the clip-on and foldable paper card in combination with the existing paper blister package 2, the package can still be opened at one side simply by applying a force in the direction of the arrow, and thus such packaging still has the problem that it is easy to steal and replace genuine products from one side and restore the packaging without detection by consumers.

Accordingly, there is a need for a package that is environmentally friendly and at the same time prevents theft and product replacement from one side, especially a paper protective case that cannot be restored once opened.

### SUMMARY

An objective is to provide a paper protective case for clip-on packaging, which can enable the entire packaging to be recycled and prevent theft and product replacement during delivery, and especially to provide a paper protective case which is not easy to restore the original state once opened.

Provided in certain embodiments is a paper protective case for clip-on packaging, which comprises a paper card body. The paper card body comprises a middle block, two long side blocks and two short side blocks, wherein the two long side blocks and the two short side blocks are integrally connected with the middle block respectively. The two long side blocks each include a first box wall portion and a first clamping portion connected to the first box wall portion. The two short side blocks each include a second box wall portion and a second clamping portion connected to the second box wall portion. Each of the first clamping portions has a first clasping angle, and each of the second clamping portions has a second clasping angle, and the first clasping angle and the second clasping angle match each other.

As mentioned above, the paper protective case can provide a middle block suitable for various product sizes, and the products are placed when the paper protective case is completed. A first clamping portion and a second clamping portion are provided to fasten the paper protective case in clip-on packaging. By virtue of the fact that a first clasping angle of the first clamping portion and a second clasping angle of the second clamping portion match each other, the paper protective case can be abutted in the clip-on packaging, and it is difficult to generate an opening by applying a force from a single side. If it is pushed hard, creases or tear marks will be generated directly at the first clasping angle and the second clasping angle, which cannot be restored. In this way, the products can be prevented from being stolen and replaced from any side during delivery.

Further provided is a device for manufacturing the paper protective case as described above, and the device comprises a paper protective case forming station. The paper protective case forming station comprises an upper jig matched with an outer contour shape of the paper card body and a lower jig corresponding to the upper jig, wherein the upper jig is adapted to transport at least one paper card body above the lower jig and align with at least one shaping opening included in the lower jig.

As described above, the device can have an upper jig and a lower jig dedicated to forming the paper protective case, both of which correspond to an outer contour shape of the paper protective case. The upper jig may transport at least one paper card body above the lower jig and align the at least one paper card body with at least one shaping opening included in the lower jig.

In one embodiment, a length of each of the first box wall portions for the paper protective case of the present invention gradually increases from the middle block towards a direction away from the middle block.

In one embodiment, the length of one side of each of the second box wall portions for the paper protective case of the present invention gradually increases from the middle block towards a direction away from the middle block.

In one embodiment, each of the first clasping angles for the paper protective case of the present invention is a convex angle.

In one embodiment, each of the second clasping angles for the paper protective case of the present invention is a concave angle.

In one embodiment, for the paper protective case of the present invention, the angle of each of the first clasping angles is slightly larger than the angle of the second clasping angle.

In one embodiment, for the paper protective case of the present invention, a first connection area between the middle block and each of the two long side blocks and the two short side blocks is provided with double K-lines which are parallel to each other. A second connection area between each of the first box wall portions and the first clamping portions is provided with a half-cut line.

In one embodiment, each of the half-cut lines for the paper protective case of the present invention occupies approximately 80% of the extension from a center of the second connection area, and both sides of the second connection area adjacent to the half-cut line are severed.

In one embodiment, for the device for manufacturing any of the above-mentioned paper protective cases in the present invention, the upper jig comprises at least one upper suction nozzle and the lower jig comprises at least one lower suction nozzle, wherein the at least one upper suction nozzle movably contacts an inner surface of the middle block, and the at least one lower suction nozzle can contact an outer surface of the middle block, and the at least one upper suction nozzle and/or the at least one lower suction nozzle are adapted to exert a downward force to complete the forming of the paper protective case.

What described above are not intended to limit the present invention, but only generally describe the technical problems that can be solved by the present invention, the technical means that can be adopted by the present invention and the technical effects that can be achieved by the present invention. According to the attached drawings and the contents described in the following embodiments, those of ordinary skill in the art can further appreciate the details of various embodiments of the present invention.

### BRIEF DESCRIPTION OF THE DRAWINGS

FIG. 1 is a schematic perspective view of a single paper card combined with a paper blister package in the prior art;

FIG. 2 is a schematic perspective view of combining clip-on packaging with the existing paper blister package in the improvement process made by the inventors;

FIG. 3 is a schematic plan view of a paper protective case before shaping according to the present invention;

FIG. 4 is a schematic perspective view of the paper protective case of the present invention after shaping and being put into clip-on packaging;

FIG. 5 is a schematic view of the paper protective case of the present invention when being pushed by an external force;

FIG. 6 is a schematic top view of a device for manufacturing the paper protective case of the present invention;

FIG. 7 shows an upper jig of the device according to the present invention; and

FIG. 8 shows a lower jig of the device according to the present invention.

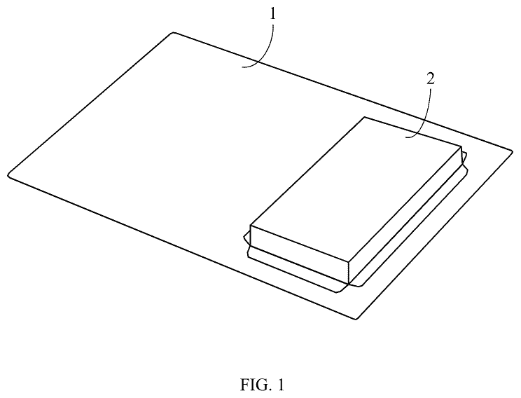

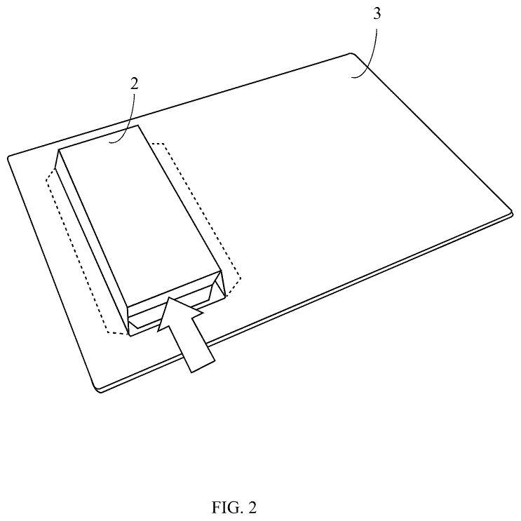

### DETAILED DESCRIPTION

Hereinafter, specific embodiments according to the present invention will be specifically described. However, the present invention may be practiced in many different forms of embodiments without departing from the spirit of the present invention, and the scope claimed in the present invention should not be interpreted as being limited to what stated in the specification.

Terms such as “first” and “second” are used herein to describe and distinguish various elements or components, instead of indicating necessary order or priority of these elements or components.

For the sake of clear presentation, the distance between lines in various figures may be exaggerated, and the relative position is not limited thereto.

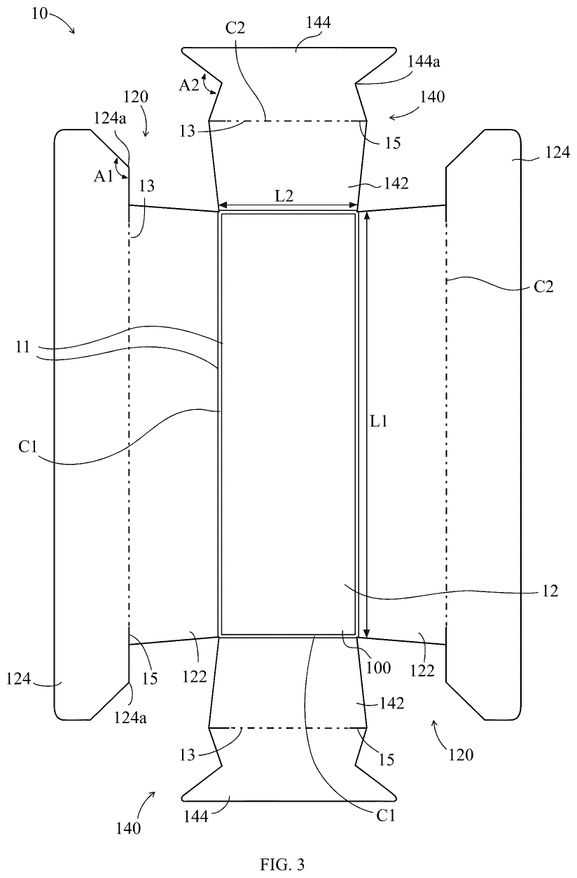

Referring to FIG. 3, there is shown a schematic plan view of a paper protective case 5 before shaping according to the present invention. The paper card body 10 comprises a middle block 100, two long side blocks 120 and two short side blocks 140. The two long side blocks 120 are oppositely arranged, the two short side blocks 140 are also oppositely arranged, the long side blocks 120 and the short side blocks 140 are disposed alternately and adjacent to each other, and the two long side blocks 120 and the two short side blocks 140 are integrally connected with the middle block 100 respectively. The whole paper card body 10 is cut from the same paper card. The two long side blocks 120 each have a first box wall portion 122 and a first clamping portion 124 connected with the first box wall portion 122 by a long side, and the two short side blocks 140 each have a second box wall portion 142 and a second clamping portion 144 connected with the second box wall portion 142 by one side. Each of the first clamping portions 124 has a first clasping angle 124a, and each of the second clamping portions 144 has a second clasping angle 144a. The first clasping angle 124a and the second clasping angle 144a respectively have angles A1 and A2 that match each other, so that after the paper protective case 5 is formed, the first clasping angle 124a and the second clasping angle 144a abut against and block each other without overlapping with each other, and thus the two long side blocks 120 and the two short side blocks 140 cannot move towards the middle block 100.

In one embodiment, the paper card body 10 may have a thickness, which is selected according to different materials, so as to protect the product during collision, and keep the shape less vulnerable to deformation after the paper protective case 5 is formed. In this embodiment, a length L1 of each first box wall portion 122 may be gradually increased from the middle block 100 in a direction away from it (i.e., in a direction away from the middle block 100), that is, the first box wall portion 122 is in the shape of an isosceles trapezoid. The length L2 of one side of each second box wall portion 142 may also be gradually increased from the middle block 100 in a direction away from it (i.e., in a direction away from the middle block 100), and the second box wall portion 142 is also in the shape of an isosceles trapezoid to facilitate shaping.

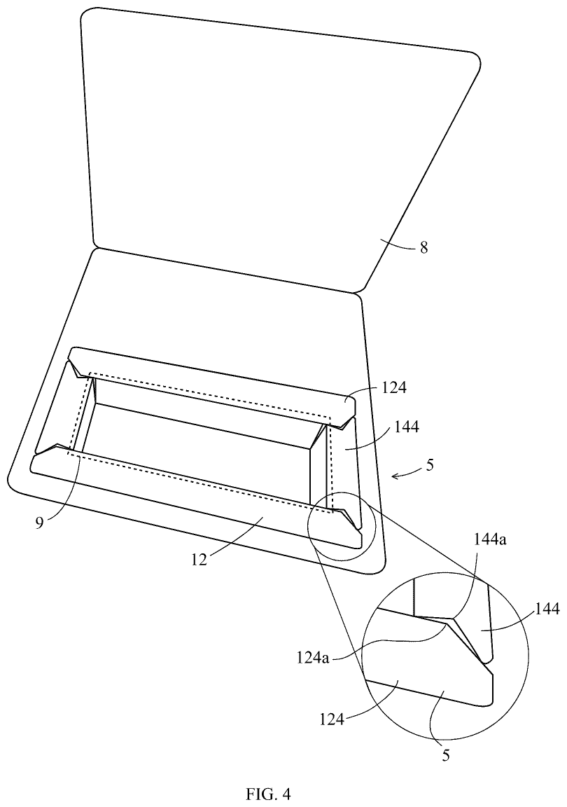

In this embodiment, each first clasping angle 124a is a convex angle, each second clasping angle 144a is a concave angle, and the angle A1 of each first clasping angle 124a is slightly larger than the angle A2 of the second clasping angle 144a. In this way, after the paper protective case 5 is formed, the first clasping angle 124a and the second clasping angle 144a do not overlap with each other but abut against and block each other, so that the first clamping portion 124 and the second clamping portion 144 cannot move towards the middle block 100 (referring to FIG. 4). In one embodiment, the convex angle and concave angle can also be set reversely.

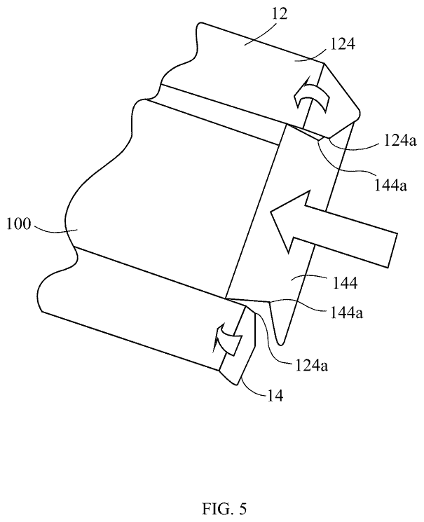

In this embodiment, before the paper protective case 5 is formed, at a first connection area C1 between the middle block 100 and each of the two long side blocks 120 and the two short side blocks 140 of the paper card body 10, double K-lines 11 (K-lines are also called “crease lines” and “indentation”) which are parallel to each other are provided. In one embodiment, the double K-lines 11 are completed by reverse creasing (performed with the product approaching the creasing machine), so that the first connection area C1 can maintain a high yield in the automatic process and present distinct and flat fold lines and thus is less vulnerable to damage in the automated concavely folding process (concave towards an inner surface 12). At a second connection area C2 between each first box wall portion 122 and first clamping portion 124 as well as between each second box wall portion 142 and the second clamping portion 144, there is provided a half-cut line 13 (shown as a dashed-dotted line in the figures, which does not mean that the half-cut line forms a tear line). The half-cut line 13 is formed by cutting from the inner surface 12 of the paper card body 10 toward an outer surface 14 (referring to FIG. 5), and it occupies approximately 80% of the extension from a center of the second connection area C2 (for example, if a length of the second connection area C2 of the short side block 140 is preset to be 23.8 mm, then the half-cut line 13 may be 19.8 mm), or it may occupy up to 90% of the extension (if a length of the second connection area C2 of the long side block 120 is preset to be 69 mm, then the half-cut line 13 may be 63 mm). The two sides of the second connection area C2 adjacent to the half-cut line 13 are severed to form a broken line 15 when the paper card body 10 is cut out in the process, so that the second connection area C2 can be easily folded concavely (towards the outer surface 14) in the automatic forming process, and the first clamping portion 124 and the second clamping portion 144 can partially pass through the broken line 15 to strengthen the fixation after the paper protective case 5 is formed, and it is not easy to deform when it is impacted after the packaging is completed. In one embodiment, the length of the broken line 15 at the second connection area C2 of the long side block 120 is the same as that at the second connection area C2 of the short side block 120 (that is, the length of the broken lines 15 at eight positions are the same with each other).

Referring to FIG. 4, after the paper card body 10 is formed into the paper protective case 5, it will be placed in the opening of a clip-on paper card 8 to complete the clip-on packaging. Specifically, the clip-on paper card 8 may be a thick paper card with a folding line, and the first clamping portion 124 and the second clamping portion 144 of the paper protection case 5 can be sandwiched between the cards after it is folded in half along the folding line. In one embodiment, after the paper protective case 5 is put into the opening, the first clamping portion 124 and the second clamping portion 144 may be first fixed in the opening by hot pressing, but whether hot pressing is performed or not and the processing method are not limited thereto.

As shall be further understood from FIG. 4, the first clamping portion 124 and the second clamping portion 144 of the paper card body 10 formed into the paper protective case 5 will not overlap with each other, and thus this will not interfere with the final folding of the clip-on paper card 8 and the packaging is completed. The first clasping angle 124a and the second clasping angle 144a abut against each other and may slightly pass through the broken line 15 to clasp with each other when subjected to external force, so as to mitigate the impact (for example, when falling to the ground) and maintain the post-forming shape.

As shown in FIG. 5, after the paper protective case 5 is put into the opening, if the first clamping portion 124 or the second clamping portion 144 is strongly pushed (for example, in the direction of the straight arrow), a crease or tear will be directly generated around the first engaging angle 124a or the second engaging angle 144a which cannot be restored, and thus it can be easily recognized that the packaging has been opened.

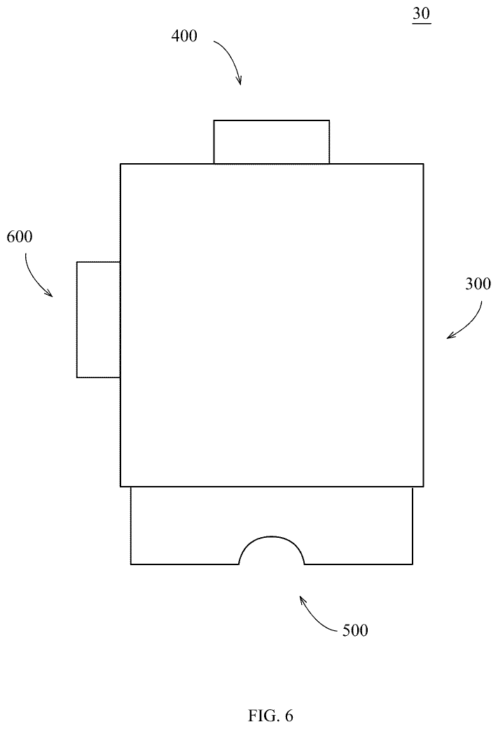

Next, referring to FIG. 4 and FIG. 6, there are shown schematic top views of a device 30 for manufacturing the paper protective case 5 as described above, and the device 30 comprises a paper protective case forming station 300. The device 30 may further comprise a paper card preparation station 400, a product placement station 500 and a packaging completion station 600, wherein the paper card preparation station 400 may position the clip-on paper card 8, the paper protective case forming station 300 forms the paper card body 10 into the paper protective case 5 in the positioned opening 9 of the clip-on paper card 8, and the product placement station 500 may place (manually or automatically) the product in the formed paper protective case 5 in the opening 9 of the clip-on paper card 8, and the packaging completion station 600 may complete the clip-on packaging by folding the clip-on paper card 8 in half and performing hot pressing around it. That is, the device 30 can complete the clip-on packaging in a one-stop manner.

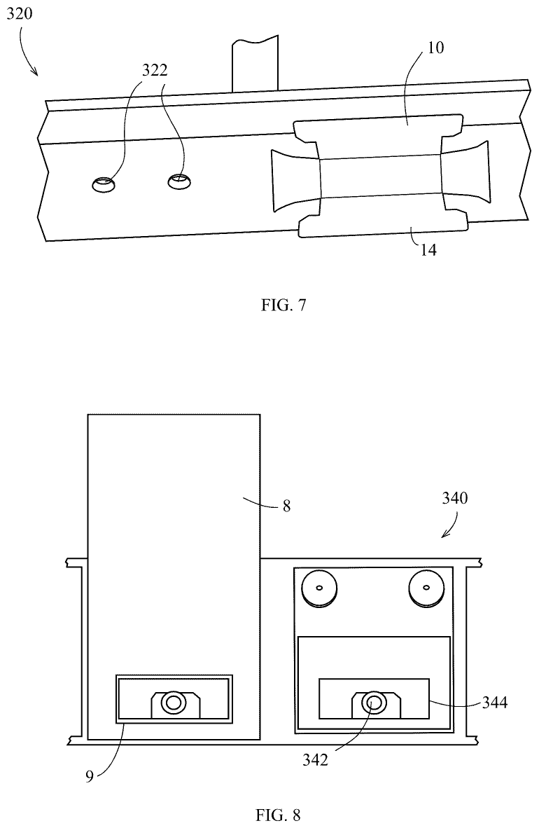

FIG. 7 is a schematic view showing an upper jig and a paper card body 10 being transported. FIG. 8 is a schematic view showing a lower jig and a clip-on paper card 8 being aligned with a shaping opening 344. In this embodiment, the paper protective case forming station 300 comprises an upper jig 320 (referring to FIG. 7) matching an outer contour shape of the paper card body 10 when the paper protective case 5 is not shaped, and a lower jig 340 (referring to FIG. 8) corresponding to the upper jig 320. The upper jig 320 is configured to transport at least one paper card body 10 above the lower jig 340 and align the at least one paper card body 10 with at least one shaping opening 344 included in the lower jig 340. In detail, the upper jig 320 may comprise at least one upper suction nozzle 322, and the lower jig 340 may comprise at least one lower suction nozzle 342. In this embodiment, the upper jig 320 adopts two upper suction nozzles 322, and the lower jig 340 adopts a lower suction nozzle 342 corresponding to a paper card body 10. The upper suction nozzle 322 first movably contacts the inner surface 12 of the middle block 100, and applies a suction force to facilitate the transportation of the paper card body 10 above the shaping opening 344. Next, a downward force is applied to push the middle block 100 to the lower suction nozzle 342, and the paper card body 10 located outside the shaping opening 344 will be blocked by the shape of the shaping opening 344. When the middle block 100 continues to be pushed downward, the first connection area C1 and the second connection area C2 will be dented, and the first box wall portion 122 and the second box wall portion 142 will change from a flat state to a nearly vertical state. When the outer surface 14 approaches or contacts the lower suction nozzle 342, the lower suction nozzle 342 may also apply a suction force to further move the middle block 100 downward, thereby further improving the forming of the paper protective case 5. Alternatively, according to different paper card thicknesses, the lower suction nozzle 342 may also apply a downward force after applying a suction force to achieve a higher forming yield or an expected forming state.

In one embodiment, the upper jig 320 and the lower jig 340 can be configured to form a plurality of paper card bodies 10 at one time.

As described above, after the paper protective case 5 of the present invention is formed the first clamping portion 124 and the second clamping portion 144 can abut against and block each other to prevent movement without overlapping with each other, and they may further slightly pass through the broken line 15 to strengthen the fixation after the forming, so that it is less vulnerable to deformation when being impacted after the clip-on paper card 8 is folded and the packaging is completed. Moreover, if one wants to open the package and steal the product from one side after the paper protective case 5 is formed, creases or tears will be generated, which cannot be restored, and thus it can be easily recognized that the packaging has been opened. That is, as compared to the traditional packaging, the paper protective case 5 of the present invention can enable the entire packaging to be recycled and the product is not easy to be stolen or replaced during delivery.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A paper protective case, applied to clip-on packaging, comprising:
a paper card body, comprising a middle block, two long side blocks and two short side blocks, wherein the two long side blocks and the two short side blocks are integrally connected with the middle block respectively;
wherein the two long side blocks each include a first box wall portion and a first clamping portion connected to the first box wall portion;
wherein the two short side blocks each include a second box wall portion and a second clamping portion connected to the second box wall portion;
wherein each of the first clamping portions has a first clasping angle, and each of the second clamping portions has a second clasping angle, and the first clasping angle and the second clasping angle match each other.

2. The paper protective case according to claim 1, wherein a length of each of the first box wall portions gradually increases from the middle block towards a direction away from the middle block.

3. The paper protective case according to claim 2, wherein the length of one side of each of the second box wall portions gradually increases from the middle block towards a direction away from the middle block.

4. The paper protective case according to claim 1, wherein each of the first clasping angles is a convex angle.

5. The paper protective case according to claim 4, wherein each of the second clasping angles is a concave angle.

6. The paper protective case according to claim 5, wherein the angle of each of the first clasping angles is slightly larger than the angle of the second clasping angle.

7. The paper protective case according to claim 1, wherein a first connection area between the middle block and each of the two long side blocks and the two short side blocks is provided with double K-lines which are parallel to each other.

8. The paper protective case according to claim 1, wherein a second connection area between each of the first box wall portions and the first clamping portions is provided with a half-cut line.

9. The paper protective case according to claim 8, wherein each of the half-cut lines occupies approximately 80% of the extension from a center of the second connection area, and both sides of the connection area adjacent to the half-cut line are severed.

10. A device for manufacturing the paper protective case according to claim 1, comprising:
a paper protective case forming station, comprising an upper jig matched with an outer contour shape of the paper card body and a lower jig corresponding to the upper jig, wherein the upper jig is adapted to transport at least one paper card body above the lower jig and align the middle block with at least one shaping opening included in the lower jig.

11. The device according to claim 10, wherein the upper jig comprises at least one upper suction nozzle and the lower jig comprises at least one lower suction nozzle, wherein the at least one upper suction nozzle movably contacts an inner surface of the middle block, and the at least one lower suction nozzle can contact an outer surface of the middle block, and the at least one upper suction nozzle and/or the at least one lower suction nozzle are adapted to exert a downward force to complete the forming of the paper protective case.
